(19) United States
(12) Patent Application Publication
(10) Pub. No.: US 2015/0024158 A1
(43) Pub. Date: Jan. 22, 2015

(54) LIGHT TRANSMITTING COPOLYMERS

(71) Applicant: Shakespeare Company, LLC, Columbia, SC (US)

(72) Inventors: Saumitra Bhargava, Columbia, SC (US); Keith D. Parks, Matthews, NC (US)

(21) Appl. No.: 14/371,831

(22) PCT Filed: Jan. 14, 2013
(86) PCT No.: PCT/US2013/021422

§ 371 Date: Jul. 11, 2014

Related U.S. Application Data
(60) Provisional application No. 61/586,015, filed on Jan. 12, 2012.

(51) Int. Cl. C08G 69/26; D01F 6/80; D02G 3/02

(52) U.S. Cl. CPC C08G 69/265; D02G 3/02; D01F 6/80; D10B 2331/02; D10B 2401/00
USPC 428/36.9; 428/220; 428/401; 528/339

(57) ABSTRACT

A copolymer which can be formed from a mixture of nylon 6,12 and nylon 6,10 along with other possible components. The nylon copolymer is not only clear (transparent) but also exhibits high dimensional stability in varying environments, limited water absorption, good wear resistance, the ability to accommodate large amounts of glass fillers, and is more resilient and tougher than either nylon 6,10 or nylon 6, 12. Moreover, the crystallinity rate of this combination of homopolymers is reduced to further improve clarity and transparency.

### CROSS-REFERENCE TO RELATED APPLICATION

The present application claims priority to U.S. Provisional Patent Application No. 61/586,015 filed Jan. 12, 2012, which is incorporated by reference as if fully rewritten herein.

### FIELD OF THE INVENTION

The present invention relates to a polymer materials, and more particularly, to a blended copolymer that is transparent.

### BACKGROUND OF THE INVENTION

Nylon polymers are typically opaque and not amenable to light transmission.

Most nylon polymers and copolymers exhibit a high degree of crystallinity and crystallize rapidly to form crystals which render the material cloudy or opaque. It would be desirable to limit crystal size to facilitate the transmission of light and improve the clarity of the nylon for applications requiring light transmission while producing nylon from readily available raw materials.

While there are many clear polymers available on the market like polycarbonates and polymethacrylate, they typically exhibit poor resistance to chemicals, have high coefficients of friction, are hard and brittle and often exhibit relatively low use temperature.

### SUMMARY OF THE INVENTION

The current disclosure is directed to a copolymer which can be formed from a mixture of nylon 6,12 and nylon 6,10 along with other possible components. A nylon copolymer formulated in accordance with this disclosure is not only clear (transparent) but also exhibits high dimensional stability in varying environments, limited water absorption, good wear resistance, the ability to accommodate large amounts of glass fillers, and is more resilient and tougher than either nylon 6,10 or nylon 6,12. Moreover, the crystallinity rate of this combination of homopolymers is reduced to further improve clarity and transparency.

That is, because of the slow rate of crystallization, the copolymer can be produced with extremely small crystals by rapidly cooling the molten copolymer before the crystals have time to grow. The resulting copolymer includes both an amorphous or glass portion and a crystallized portion. This semi-crystalline copolymer can be produced with crystals less than one half micron in size or smaller, such as 0.3 micron or smaller which allows for the transmission of both visible and ultraviolet light.

Potential applications of this copolymer include:
1. Clear filament bristles for brushes;
2. Scratch resistant, chemical resistant transparent films;
3. Clear, chemical resistant cable sheathing;
4. Precision engineering parts;
5. Clear electrical relays, electrical contacts, electrical plugs, and sockets;
6. Engineering polymers with excellent mechanical properties;
7. Water applications such as heated water tanks;
8. Packaging of pharmaceutical and food products; and
9. Higher end use temperature capable clear nylon.

### DESCRIPTION OF A REPRESENTATIVE EMBODIMENT

Although there are many possible copolymers that can be formed with the desirable physical properties noted above, one representative copolymer of nylon 6,12 and nylon 6,10 can be easily and economically produced with only three basic relatively low cost components. In particular, a combination of hexamethylene diamine (HMD), dodecanedioic acid (DDDA) and sebacic acid can be processed using well known reactor operating conditions used for reacting nylon 6,12 and nylon 6,10, However, if these three basic components are mechanically compounded and blended together by melting and mixing in a twin-screw extruder, the resulting end product is not clear or transparent, but rather is cloudy. Nylon 6, 10 and Nylon 6, 12 homopolymers are opaque as well.

When HMD, DDDA and sebacic acid, the monomers of nylon 6, 10 and nylon 6, 12, are reacted under standard nylon production temperature and pressure conditions in a pressure vessel, the resulting product is a transparent copolymer that can be further processed to form any number of clear transparent products as described below. During processing in a reactor, diamine, [HMD (H₂N—(CH₂)₆—NH₂)], reacts with diacid, [DDDA (HOOC—(CH₂)₁₀—COOH)] or sebacic acid (HOOC—(CH₂)₈—COOH)], to form amide linkages. This reaction occurs on both end of the monomers generating a linear molecule composed of alternating diacid and diamine monomers connected by amide linkages. In the copolymer the diacid monomers (DDDA and sebacic acid) are in random order. (Whereas, a homopolymer of N6,10 is composed of only amide linkages from HMD and sebacic acid.)

The resulting copolymer is a clear semi-crystalline copolymer having very small crystals less than 0.3 microns in length surrounded by an amorphous or “glass” matrix. This material exhibits many desirable physical properties including a high crystalline melt point around 180° C., high resistance to scratching, good wear resistance, a relatively low density around 1.0, a slow rate of crystallization (around 100 seconds), excellent light transmission (>90%) including ultraviolet light transmission, very low extractables and little degradation over time of physical properties such as strength and flexibility, virtually no leaching out of unreacted monomers or oligomers, a combination of flexibility and transparency at a relatively high melt point and the absence of bulky cyclic monomers.

This particular copolymer system is “neat” insofar as no other additives or polymers are required. Moreover, because this copolymer system is “linear” without the inclusion of bulky cyclic monomers or aromatic rings, the resulting nylon copolymer is very flexible as compared to other transparent nylons which are brittle, tinted and which can shatter. This shatter resistance, combined with clarity of light transmission makes this copolymer very well suited for use as a material for lenses and frames for eye glasses, contact lenses as well as other applications where transparency is needed such as liquid and fluid filters, clear covers for gauges, instruments, wire and electronics, and tubing.

As compared to known “clear” nylon polymers, the copolymers described herein are less expensive in terms of starting materials as well as processing costs. Conventional “clear” nylon polymers are formed with aromatic ring compounds and/or “bulky” (nonlinear) groups which form amorphous polymers having substantially no melting point, only glass transitions points, typically below 120° C. This amorphous or “glass” structure is generally dimensionally unstable at higher temperatures, such as above 60° C., where the material flow begins to accelerate. If weight is applied to such amorphous material, the material will permanently deform.

In contrast, the semi-crystalline copolymers described herein emerge from a reactor as slightly crystallized clear pellets. When these pellets are further processed by, for example, molding or extrusion, the crystallization rate during this subsequent processing is naturally “slow” as compared to conventional clear nylon polymers. For example, the crystallization of conventional nylon polymers takes around ten seconds or less, whereas the crystallization of the pellets described herein is around 100 seconds. Other transparent articles of manufacture that may be formed by molding or extruding the pellets in addition to those previously described above include films and sheets, filament yarn and monofilaments, and tubing. It has been found that it is possible to manufacture using the semi-crystalline copolymers described herein transparent films, sheets, filament yarn and monofilaments less than one-eighth of an inch thick and transparent tubing having a wall thickness less than one-eighth of an inch thick.

While a copolymer of HMD. DDDA and sebacic acid has been described above, other clear nylon polymers can be produced using standard operating conditions for the production of nylon 6,10 or nylon 6,12. Table 1 lists various combinations of nylon polymers and diacids that can be combined to produce copolymers in accordance with this disclosure.

TABLE 1

| | | | |
|---|---|---|---|
| 1st component | 2nd component | 3rd component | 4th component |

Economical, Functional and most useful copolymers relating to the invention.

| | | | |
|---|---|---|---|
| 6:10 (HMD, C10 diacid) | 6:12 (HMD, C12 diacid) | | |
| 6:10 (HMD, C10 diacid) | 6:9 (HMD, C9 diacid) | | |
| 6:10 (HMD, C10 diacid) | 6:14 (HMD, C14 diacid) | | |
| 6:12 (HMD, C12 diacid) | 6:9 (HMD, C9 diacid) | | |
| 6:12 (HMD, C12 diacid) | 6:14 (HMD, C14 diacid) | | |
| 6:12 (HMD, C12 diacid) | 6:11 (HMD, C11 diacid) | | |
| 6:12 (HMD, C12 diacid) | 6:10 (HMD, C10 diacid) | 6:9 (HMD, C9 diacid) | |
| 6:12 (HMD, C12 diacid) | 6:10 (HMD, C10 diacid) | 6:14 (HMD, C14 diacid) | |
| 6:12 (HMD, C12 diacid) | 6:10 (HMD, C10 diacid) | 6:11 (HMD, C11 diacid) | |
| 6:12 (HMD, C12 diaoid) | 6:14 (HMD, C14 diacid) | 6:9 (HMD, C9 diacid) | |
| 6:12 (HMD, C12 diacid) | 6:10 (HMD, C10 diacid) | 6:14 (HMD, C14 diacid) | 6:9 (HMD, C9 diacid) |
| 6:12 (HMD, C12 diacid) | 6:10 (HMD, C10 diacid) | 6:14 (HMD, C14 diacid) | 6:11 (HMD, C11 diacid) |

Functional, but not too economical

| | |
|---|---|
| 6:12 (HMD, C12 diacid) | 6:13 (HMD, C13 diacid) |
| 6:10 (HMD, C10 diacid) | 6:13 (HMD, C13 diacid) |
| 6:12 (HMD, C12 diacid) | 6:15 (HMD, C15 diacid) |
| 6:10 (HMD, C10 diacid) | 6:15 (HMD, C15 diacid) |

Economical, but limited functionality

| | |
|---|---|
| 6:10 (HMD, C10 diacid) | 6:6 (HMD, C6 diacid) |
| 6:12 (HMD, C12 diacid) | 6:6 (HMD, C6 diacid) |
| 6:9 (HMD, C9 diacid) | 6:6 (HMD, C6 diacid) |
| 6:10 (HMD, C10 diacid) | Capro |
| 6:12 (HMD, C12 diacid) | Capro |

Table 2 lists various combinations of nylon polymers that can be combined to produce copolymers in accordance with this disclosure. A BYK haze-gird plus instrument was utilized to measure light transmission and haze of injected molded disks per ASTM D 1003. The listed copolymers were found to have light transmission >85% and haze <1%.

TABLE 2

| | Light | |
|---|---|---|
| Sample Composition mol % | Transmission, % | Haze, % |
| Copolymer-90 mol % N612, | 88 | <1% |
| 10 mol % N610 | | |
| Copolymer-85 mol % N612, | 91 | <1% |
| 15 mol % N610 | | |
| Copolymer-90 mol % N612, | 91 | <1% |
| 10 mol % N669 | | |

The following list of diacids identifies those diacids which can be used to produce copolymers in accordance with this disclosure.
HMD hexamethylene diamine
C14 diacid tetradecandedioic acid
C13 diacid brassylic acid
C12 diacid dodecanedioic acid
C11 diacid undecanedioic acid
C10 diacid sebacic acid
C9 diacid azelaic acid
C6 diacid adipic acid
Capro caprolactum

### EXAMPLE

### Preparation of 60/40 Copolymer of Nylon 6,12 and Nylon 6,10

The following preparation yields 1750 g of copolymer resin.

In 1875 g of water, add 679.5 g of HMD and 808.0 g of DDDA. Heat the mixture at 75° C. under a nitrogen blanket with continuous stirring to dissolve DDDA. When solution becomes clear, add 473.0 g of sebacic acid and continue stirring in the same vessel at 75° C. Adjust the pH to 7.7 (apparent pH of 5% salt solution) by adding HMD or sebacic acid. Add 1 g of antifoam solution, and 500 mg of any phosphoric acid, phosphonate or phosphite catalyst.

Reactor vessel (Parr) is 2 gallon, high pressure, agitated reactor. Purge the reactor vessel with nitrogen for 20 minutes. Seal the reactor vessel and heat to 150 psi. Hold the pressure to 150 psi until the mixture reaches 230° C. Then depressurize the reactor vessel at 2.5 psi/min to 20 psi. Then begin a 30 psi nitrogen purge until the temperature reaches 252° C. At this point most of the water has left the reactor vessel.

Begin building vacuum slowly and continue pulling vacuum until the desired viscosity as measured by agitator torque is reached. Pressurize the reactor vessel with nitrogen, open the valve at the bottom of the reactor vessel. The bottom of the reactor vessel contains a die with two holes which results in strands. The strands are cooled in a quench trough containing room temperature water. Strands are fed into a pelletizer to yield copolymer pellets.

It can now be appreciated that an addition of a small amount of comonomer to either nylon 6.10 or nylon 6,12 results in a high clarity copolymer which allows for greater amounts of loading with fillers such as glass and mineral fillers. The copolymers described herein can be used as engineering plastics and for monofilament applications. The physical properties of nylon 6,10 and nylon 6,12 are improved without the need for added diluents, plasticizers or other additives. Notably, the physical properties of nylon 12, which is a material of choice in many demanding engineering applications requiring barrier properties, superior chemical resistance and resilency, can be matched with those of the copolymers described herein at a 40-50% lower cost with no extractable monomer. Moreover, these copolymers can be tailored to exhibit a very slow crystallization rate particularly well suited for high speed specialty processing.

It will be appreciated by those skilled in the art that the above light transmitting copolymers are merely representative of the many possible embodiments of the disclosure and that the scope of the disclosure should not be limited thereto, but instead should only be limited according to the following claims.

What is claimed is:

1. A copolymer of nylon 6,10 and nylon 6,12.

2. The copolymer of claim 1, wherein said copolymer comprises a semi-crystalline structure.

3. The copolymer of claim 1, wherein said copolymer is transparent.

4. The copolymer of claim 1, wherein said copolymer is formed by reacting HMD, DDDA and sebacic acid.

5. The copolymer of claim 1, wherein said copolymer comprises crystals less than 0.5 micron in length.

6. The copolymer of claim 1, wherein said copolymer has a density of about 1.0.

7. The copolymer of claim 1, wherein said copolymer is a linear copolymer without the presence of cyclic monomers and aromatic rings.

8. The copolymer of claim 1, wherein said copolymer has a melt point around or above 180° C.

9. The copolymer of claim 1, wherein said copolymer comprises of random linear arrangement of nylon 6,10 and nylon 6,12 linkages.

10. An article of manufacture, comprising:
HMD, DDDA and sebacic acid.

11. The article of claim 10, wherein said HMD, DDDA and sebacic acid form copolymers of nylon.

12. The article of claim 10, wherein said article of manufacture is transparent.

13. The article of claim 10, wherein said article of manufacture comprises a lens.

14. The article of claim 10, wherein said article of manufacture comprises a transparent film or sheet.

15. The article of claim 10, wherein said article of manufacture comprises a transparent extruded article.

16. The article of claim 10, wherein said article of manufacture comprises a transparent filament yarn or monofilament.

17. The article of claim 14, wherein said film or sheet is less than one-eighth of an inch thick.

18. The article of claim 16, wherein said filament yarn or monofilament is less than one-eighth of an inch thick.

19. The article of claim 10, wherein said article of manufacture comprises tubing.

20. The article of claim 19, wherein wall thickness of said tubing is less than one-eighth of an inch thick.

21. A copolymer of nylon 6,10 and nylon 6,9.

22. A copolymer of nylon 6,12 and nylon 6,9,
